(19) United States
(12) Patent Application Publication
(10) Pub. No.: US 2011/0167407 A1
(43) Pub. Date: Jul. 7, 2011

(54) SYSTEM AND METHOD FOR SOFTWARE DATA REFERENCE OBFUSCATION

(75) Inventors: Pierre Betouin, Boulogne (FR); Mathieu Ciet, Paris (FR); Augustin J. Farrugia, Cupertino, CA (US); Julien Lerouge, Santa Clara, CA (US); Ginger M. Myles, San Jose, CA (US)

(73) Assignee: Apple Inc., Cupertino, CA (US)

(21) Appl. No.: 12/683,145

(22) Filed: Jan. 6, 2010

(51) Int. Cl. G06F 9/44

(52) U.S. Cl. 717/120

(57) ABSTRACT

Disclosed herein are systems, methods, and computer-readable storage media for obfuscating software data references. The obfuscation process locates pointers to data within source code and loads the pointers into an ordered set of pools. The process further shuffles the pointers in the ordered set of pools and adds a function within the source code that when executed uses the ordered set of pools to retrieve the data. The obfuscation process utilizes pool entry shuffling, pool chaining shuffling and cross-pointer shuffling.

### BACKGROUND

1. Technical Field

The present disclosure relates to software source code obfuscation and more specifically to data reference protection.

2. Introduction

Software publishers often attempt to restrict access to portions of compiled software executables to thwart reverse engineering attempts while still allowing the executables to function properly. Reverse engineering is the practice of dissecting and/or analyzing software to understand how it works. On certain systems, reverse engineering can retrieve information stored within software such as data related to cryptographic keys or copy protection schemes. Reverse engineers can even tamper with the software itself or call specific portions of the software for unauthorized purposes.

In the field of security for open platforms, obfuscation is a desirable way to protect secure portions of code. Obfuscation is the process of making source code or machine code difficult to read and/or understand. Software programmers may obfuscate code for several reasons, one of which is security. Indeed, some designers of such platforms have an obligation to protect keys, hide which processes are running, etc. Attackers try to gain information that allows copies of the software to be made, or in other cases to extract sensitive information such as keys used to protect access.

If an attacker retrieves the location of well-known data, the attacker is able to locate all of the functions that access the well-known data by cross-referencing instructions. Therefore, making the well-known data harder for an attacker to locate or access increases security.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and computer-readable storage media for obfuscating software code based on protecting data references. FIG. 1 illustrates an exemplary system 100 that can practice the methods disclosed herein. The method embodiment of FIG. 3 will be described with the steps being performed by such an exemplary system of FIG. 1. The system 100 locates pointers to data within source code (310), loads pointers within the source code into an ordered set of pools (320), shuffles the pointers in the ordered set of pools (330) and adds a function within the source code that when executed uses the ordered set of pools to retrieve the data (340). In this and other embodiments, the system 100 can shuffle the pointers randomly or deterministically.

The system 100 generates the ordered set of pools of pointers by linking pools of pointers together with pointers. The system 100 merges function input parameters together. The first pool in the ordered set of pools has a fixed address and links to a number of additional pools through entries in the pools. In this manner, the system 100 converts references to data (pointers) in the source code according to the approach of accessing the data through the pools of pointers. An attacker must follow all of the operations on the pools of pointers to access the data. Those of skill in the art will understand the use of pointers in writing source code to reference data or for other programming purposes.

In one embodiment, the system alters or modifies an existing generated set of pools by at least one of pool entry shuffling, pool chaining shuffling, and cross-pointer shuffling. A cross-pointer is a pointer to another pointer. Pool entry shuffling includes at least one of replicating, switching or moving pool entries within a pool. One approach for pool chaining shuffling includes identifying the first pool in the ordered set of pools with a fixed address and modifying the location of the next pool link within a pool. Cross-pointer shuffling can include at least one of addition of a cross-pointer, removal of a cross-pointer, replication of a cross-pointer, and switching or moving of a cross pointer.

A function to retrieve the data performs the following steps: (1) selects a pointer in a first pool in the ordered set of pools; (2) follows the selected pointer or selected next pointer to identify a next pool in the ordered set of pools; (3) defines the next pool as a current pool and iteratively selecting a next pointer in the current pool and returning to step (2) until a function indicates that the selected next pointer in the current pool points to the data or pointer.

In one aspect, the principles disclosed herein apply to a compiler which generates code according to the data reference obfuscation. In another aspect, the principles herein apply to a computing device such as is shown in FIG. 1 executing code obfuscated based on the data reference obfuscation process. Other applications and combinations of the principles disclosed herein also exist, for example combining with other obfuscation techniques such as data masking, or randomly obfuscating code.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an exemplary compiler;

FIG. 3 illustrates an exemplary method embodiment;

FIG. 4 illustrates an exemplary approach for constructing pools of pointers;

FIG. 5 illustrates an exemplary obfuscation process;

FIG. 6 illustrates an ordered set of pools of pointers;

FIG. 7 illustrates an exemplary data retrieval process;

FIGS. 8 and 9 illustrate an exemplary approach for pool chaining shuffling;

FIGS. 10 and 11 illustrate an exemplary approach for pool entry shuffling and cross-pointer shuffling; and

FIG. 12 illustrates an example call graph.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

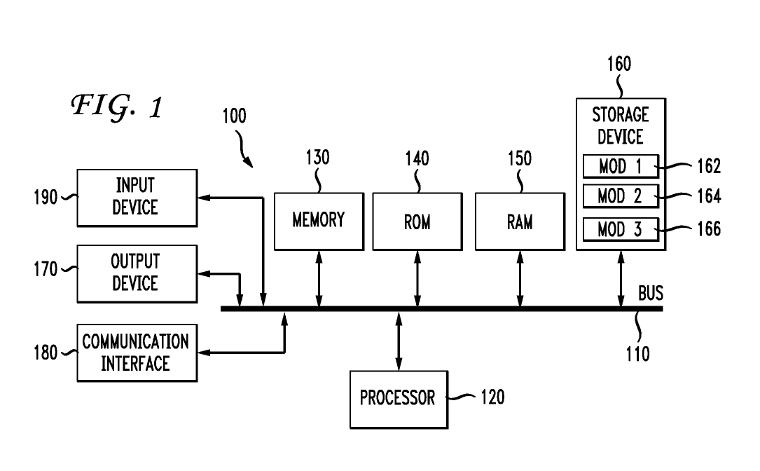

With reference to FIG. 1, an exemplary system or computing device 100 includes a general-purpose computing device having a processing unit (CPU or processor) 120 and a system bus 110 that couples various system components including the system memory 130 such as read only memory (ROM) 140 and random access memory (RAM) 150 to the processor 120. These and other modules can be configured to control the processor 120 to perform various actions. Other system memory 130 may be available for use as well. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a tangible and/or intangible computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Tangible computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. The input device 190 may be used by the presenter to indicate the beginning of a speech search query. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example, the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage media. Generally speaking, such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

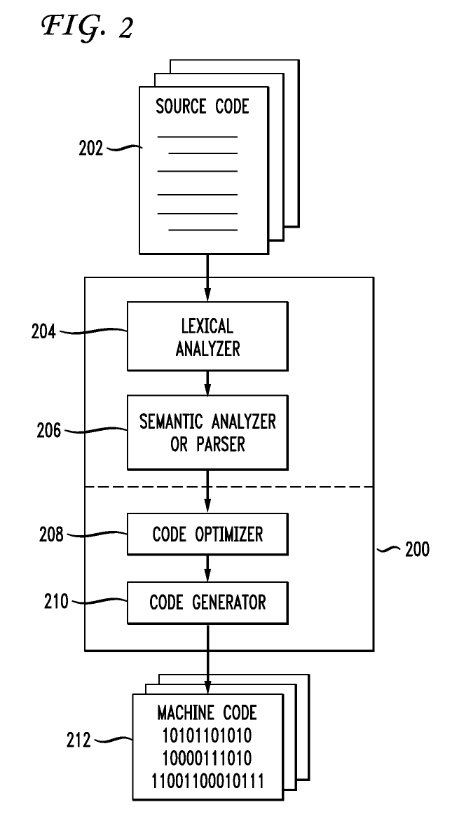

Any or all of the steps and/or modules can be integrated with or interact with a compiler. FIG. 2 illustrates a block diagram of an exemplary compiler 200. The modules and elements of the exemplary compiler 200 can be modified and/or added to in order to implement the data reference obfuscation principles disclosed herein. A compiler 200 converts human-readable source code 202 to object code or machine code 212 which is understandable to and typically executable by a computing device 100. A compiler 200 typically performs the following representative operations as well as other operations: lexical analysis 204, preprocessing, parsing 206, semantic analysis 206, code optimization 208, and code generation 210. Compilers are important in the world of computer science and software because they allow programmers to write software using high level languages and convert those high level instructions to binary machine code 212.

The compiler 200 takes as input source code 202 for a computer program written in a programming language like ANSI C, Perl, Objective-C, Java, etc. The compiler 200 passes the code to the front end of the compiler 200 which includes the lexical analyzer 204 and the semantic analyzer or parser 206. At this stage or at any other stage in the compiler 200, a module shown or not shown can perform all or part of the steps outlined above. The compiler 200 then operates on the source 202 in the back end, which includes the code optimizer 208 and the code generator 210. Often the division between the front end and the back end of a compiler is somewhat blurred. The compiler 200 can include other modules and can appear in different configurations. Other possible front end components include a preprocessing module and a semantic analysis module, not shown. The front end produces an intermediate representation of the code which is passed to the back end of the compiler 200. The back end of a compiler 200 can include an optimizer 208 and a code generator 210. Finally, the code generator 210 produces machine code 212 or object code. A linker, not shown, can combine the output 212 from several related compiled projects into a single executable file. An obfuscation tool separate from the compiler 200 can process the machine code 212 according to all or part of the steps outlined above to produce modified or obfuscated machine code Likewise, an obfuscation tool can operate on source code 202 to produce modified or obfuscated source code which is passed to a regular, unmodified compiler 200. Additionally, an obfuscation tool can operate on code after the front end. In one aspect, a module in the compiler, a pre-processing tool, and/or a post-processing tool operating together perform the overall task of obfuscation based on protecting data references. Other compiler components and modules can be added within the spirit and scope of this disclosure.

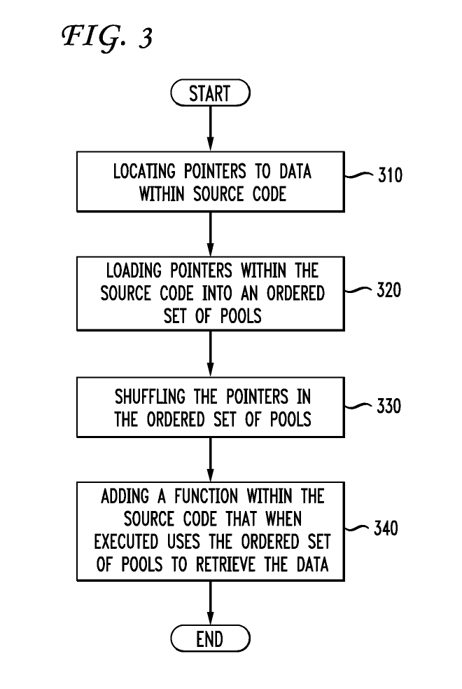

Having disclosed some basic system components, the disclosure now turns to the exemplary method embodiment shown in FIG. 3. For the sake of clarity, the method is discussed in terms of an exemplary system 100 such as is shown in FIG. 1 that performs the steps disclosed herein. For example, the system 100 can have stored in non-transitory memory a program that controls the system 100 to perform these steps.

FIG. 3 illustrates the exemplary method embodiment. A system 100 performs data obfuscation by: locating pointers to data within source code (310); loading pointers within the source code into an ordered set of pools (320); shuffling the pointers in the ordered set of pools (330); and adding a function within the source code that when executed uses the ordered set of pools to retrieve the data (340). This method renders it more difficult for an attacker to reverse engineer the process, and as a result gaining access to data. The function to retrieve data can include the following steps: (1) selecting a pointer in a first pool in the ordered set of pools, (2) following the selected pointer or selected next pointer to identify a next pool in the ordered set of pools, and (3) defining the next pool as a current pool and iteratively selecting a next pointer in the current pool and returning to step (2) until a second function indicates that the selected next pointer in the current pool points to the data. The system can replace the pointer to data within source code with the function to retrieve the data. The system 100 can generate the ordered set of pools by merging function input parameters together. The first pool in the ordered set of pools can have a fixed address. The system can automatically select the ordered set of pools of pointers based on desired performance attributes. The system can perform code obfuscation deterministically or randomly. The system 100 uses a pseudo-random number generator (PRNG) to perform code obfuscation deterministically. A PRNG is an algorithm that generates a sequence of numbers that approximates the properties of random numbers. A sequence of numbers generated by a PRNG is not truly random; the sequence of numbers can be reproduced.

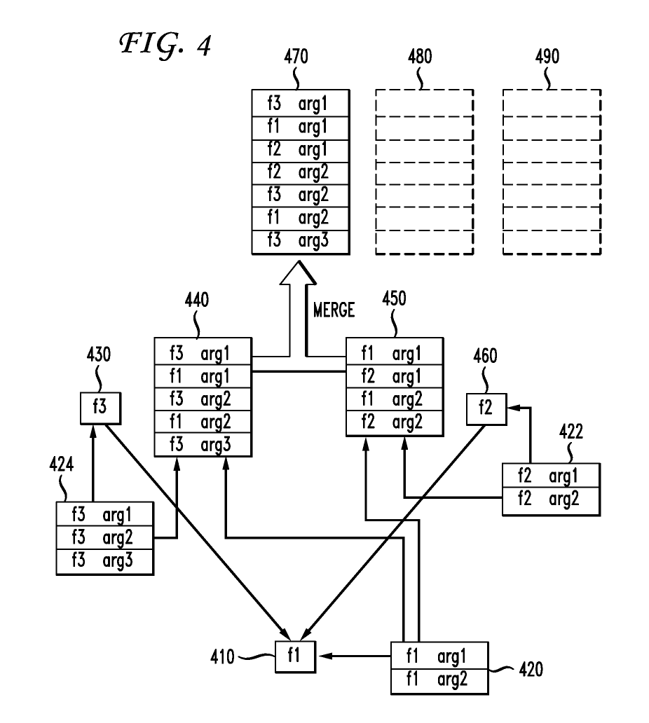

Next, an example algorithm to construct an ordered set of pools of pointers is discussed. FIG. 4 illustrates the construction of a pool by creating a call-graph of functions. A call graph is a directed graph that represents calling relationships between subroutines in a computer program. A system 100 determines the first function which is called in terms of a call-graph the lowest function. In FIG. 4, f1, f2 and f3 (410, 460 and 430 respectively) represent functions within source code. The functions f2 and f3 both call f1. The function f1 accepts two arguments f1 arg1 and f1 arg2 420 as input. Function f2 accepts two parameters f2 arg1 and f2 arg2 as input 422 and function f3 accepts three parameters f3 arg1, f3 arg2 and f3 arg3 as input 424. The system 100 stores the inputs of function f1 in two consecutive positions in memory 420. The system 100 merges the input 422 to f2 with the input 420 to f1 in block 450, and it merges the input 424 to f3 with the input 420 to f1 in blocks 440. The system 100 then merges the two sets of input parameters 440, 450 to produce a pool of pointers 470. The system 100 can extend the algorithm presented to create pools of pointers 480, 490 by iteratively performing the merge operation or using different functions and including additional parameters in the merge operation when there are more than two functions and additional parameters. Additionally, the system can extend the algorithm to include any number of functions and input parameters. The system 100 can fill subsequent pools 480, 490 in a similar manner using different functions, for example f4, f5 and f6. The system 100 creates an ordered set of pools of pointers by ordering the generated pools and linking the pools together with pointers. The system can link the pools together by adding a pointer in pool 1 pointing to pool 2, and adding a pointer in pool 2 pointing to pool 3. Alternatively, the system 100 can create an ordered set of pools of pointers by distributing entries in a pool 470 to subsequent pools 480, 490. For example, the system 100 can move entries 470 f1 arg1 and f2 arg1 to a subsequent pool 480. Other pool generating and pool linking approaches within the spirit and scope of this disclosure exist.

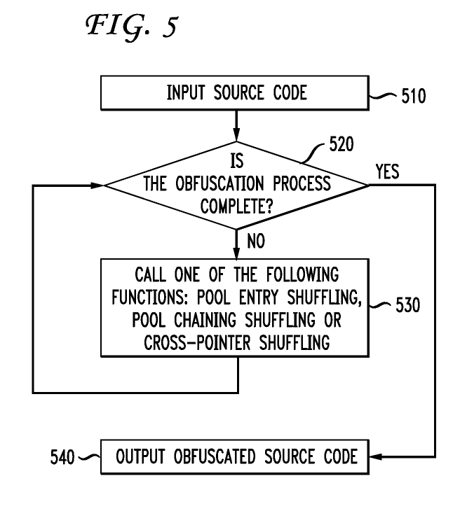

FIG. 5 illustrates an example obfuscation process. As a general overview, a system 100 can convert data references to pools of pointers to data. The pools can store data such as fixed values, function input data, function output data, and so forth. The system 100 accesses the data by traversing the pools of pointers, and a deterministic function determines when the pool traversing process is complete. The system 100 receives source code 510 as input, but can also accept compiled code or code at any intermediate stage of compilation. In one aspect, the system 100 obfuscates on explicitly declared variables, but the system 100 can also obfuscate other non-explicitly declared variables. A function 520 checks if the obfuscation process is complete. If the process is not complete, the system 100 selects and executes or causes to be executed one of the pool entry shuffling, pool chaining shuffling or cross-pointer shuffling functions 530 to shuffle the data references (pointers). The system 100 returns to the step of checking if the obfuscation process is complete 520. If the process is complete, the system 100 outputs the obfuscated source code 540. The obfuscated source code contains functions that utilize the pools of pointers to data instead of direct data references. Obfuscating source code in this manner renders it more difficult for an attacker to gain access to the data.

The pointer shuffling process 530 in FIG. 5 includes at least three variations which are discussed herein. Other shuffling approaches within the spirit and scope of this disclosure exist. In the first variation, pool entry shuffling, the system 100 shuffles the entries within the pools. In the second variation, pool chaining shuffling, the system 100 changes the location of the links to subsequent pools. In the third variation, cross-pointer shuffling, the system 100 adds, removes or shuffles cross-pointers. The system 100 can perform any or all of the exemplary three pointer shuffling actions on the ordered set of pools together, interchangeably, and/or independently.

All of the operations on the pools or on the pointers are deterministic and fixed at the source code level, before the source code is compiled. A function analyzes the source code, detects the use of pointers and obfuscates the pointers using the process described here. This approach allows the loading of all data references into pools of pointers. Due to the shuffling, the system 100 obfuscates the pointer indices such that an attacker is forced to follow all of the operations performed on the pool of pointers in order to get to the data. This approach introduces a large amount of extra work for the attacker to gain access to data.

For example, consider a pointer p points to a fixed value in unobfuscated source code. One level of indirection exists to access the fixed value through pointer p. The system obfuscates the source code containing pointer p by loading pointer p into the first entry of the second pool. After the obfuscation, three levels of indirection exist to access the fixed value through pointer p. The first level of indirection is accessing the first pool, the second level of indirection is accessing the second pool through the first pool and the third level of indirection is following pointer p stored in the second pool to retrieve the fixed value. The system 100 added multiple levels of indirection to access the fixed value stored by p. Adding levels of indirection increase the security of the system since the attacker must complete more steps to access the data. Many variations and combinations of code obfuscation can be implemented. For example p could store a function input instead of a fixed value or the system could obfuscate the code so that p is stored in a different pool with a different number of indirections. This example should not be limiting in any way.

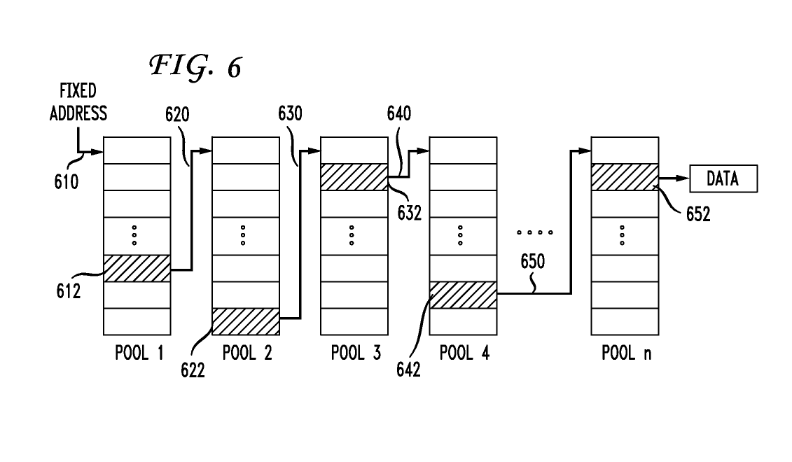

FIG. 6 illustrates an exemplary ordered set of pools of pointers. Pool 1 is the first pool in the ordered set of n number of pools and has a fixed address 610. The fixed address allows code in a program to access the first pool and thereby gain access to data pointed to by the set of pools of pointers. Given pools with s number of blocks, block 612 in Pool 1 links 620 Pool 1 to Pool 2, block 622 in Pool 2 links 630 Pool 2 to Pool 3 and so on. The pools continue linking via blocks 632, 642 to subsequent pools in this manner until the system establishes a link to the last pool, Pool n. The blocks in each pool represent pointers. The number of pools n and their lengths are flexible; each pool may have a different length. The only fixed and unchanged address is the address of Pool 1, although Pool 1's length can grow or shrink. In one aspect, an initialization function returns the fixed address 610 of Pool 1 and can be set as a standard memory allocation. The various pointers can be dummy pointers which point to invalid or meaningless memory locations or can be parts of one or more other pointer chains through the pools. Note that the actual pointer to data need not be stored in the last pool in the set; the pointer may be stored in any block in any pool. Although the pointers in blocks 612, 622, 632, 642 each link a pool to a first block in a respective next pool, this is not always the case. The pointers linking pools together may point to any block within a subsequent pool.

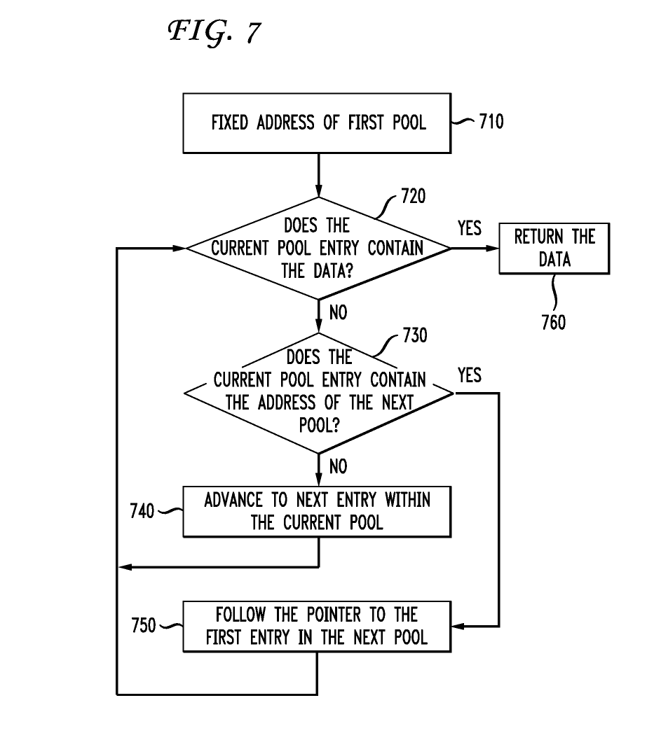

FIG. 7 illustrates the process in which system 100 retrieves data 760 by traversing the ordered set of pools. The system begins (710) at the fixed address 610 of the pools of pointers. A deterministic function checks if the entry at the current address contains the data (720). If the current address does not contain the data, the system determines (730) if the entry contains the address of the next pool. If the entry does not contain the address of the next pool, the system advances to the next entry in the pool (740) and the deterministic function checks if the entry at the current address contains the data. This process continues until the system locates the data or the entry contains the address of the next pool. When the entry of a pool contains the address of the next pool, the system follows the pointer to the first entry in the next pool (750). The deterministic function checks if the entry at the current address contains the data (720). When the system locates the pointer p, the process is complete and the system returns 760 the data.

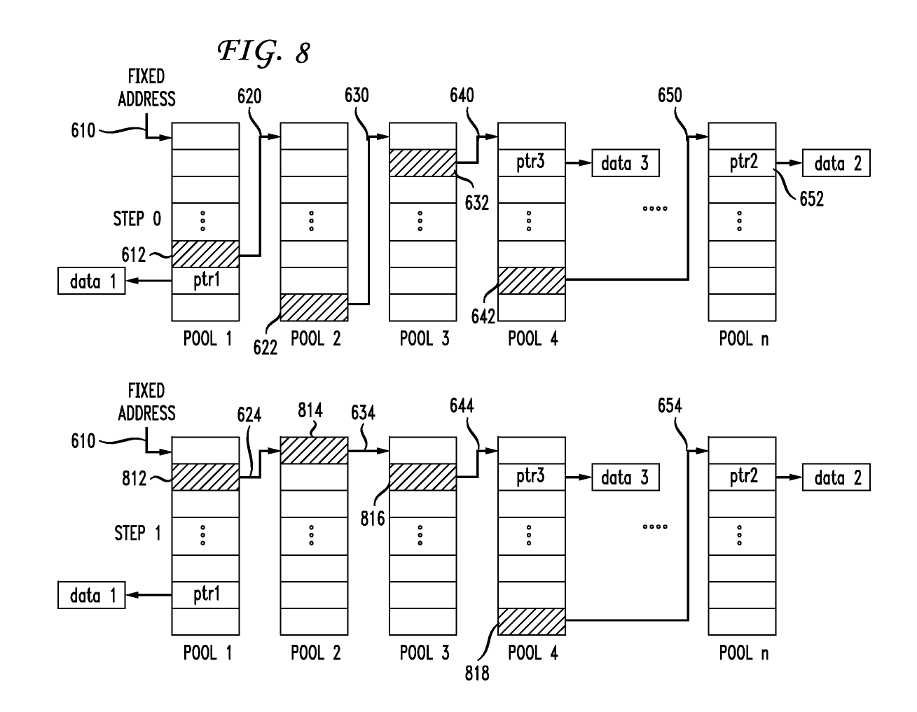

Next, the shuffling processes performed on the ordered set of pointers are discussed. FIG. 8 illustrates the pool chaining shuffling feature of the obfuscation process. The pointers ptr1, ptr2 and ptr3 point to data1, data2 and data3, respectively in memory, not to another location within the pools. Each time the system performs pool chaining shuffling, the system updates the chain path of the pools, with the exception of the fixed address 610 of Pool 1. Suppose there are s number of blocks in a pool; each block represents a pointer and block 0 is the first block in a pool. In Step 0, the address pointing to Pool 2 620 is stored in block 612 in Pool 1. The address pointing to Pool 3 630 is stored in block 622 in Pool 2. Subsequent pools 3 and 4 are linked together 630, 640 via pointers in blocks 632, 642 in a similar manner in Step 0 until all of the pools are linked together, ending with a pointer 650 in Pool n. In one aspect, a pointer in a pool can refer back to the pool within which the pointer is located. Block 652 points via ptr2 to the data 2.

In FIG. 8, Step 1 illustrates the updated chain path after the system 100 shuffles the pool chains in the set of pools. The system 100 updates the location of the address pointing 624 to Pool 2 and stores the updated location in block 812 of Pool 1. The system 100 updates the location of the address 634 of Pool 3 and stores this updated location in block 814 in Pool 2. The system 100 stores the address 644 of Pool 4 in block 816. The system 100 updates the location of the address 654 of Pool n in block 818. Note that the location of data pointers ptr1, ptr2 and ptr3, which each point respectively to data1, data2, and data3, do not have to change during the pool chaining shuffling operation; only the chaining between the pools changes. In another aspect, the locations of data pointers may change in the shuffling.

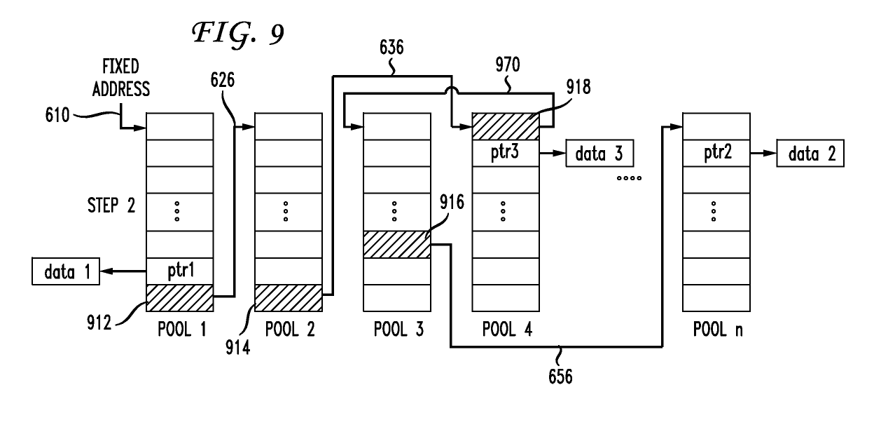

FIG. 9 continues to show another step of shuffling in addition to the steps of FIG. 8. Step 2 in FIG. 9 illustrates the updated chain path after the system 100 shuffles the pool chains a second time. The system 100 does not change the location 610 of Pool 1, because that address is fixed. The system 100 updates the location of the address pointing 626 to Pool 2 and stores the updated address in block 912 in Pool 1. Block 914 in pool 2 stores the location 636 of Pool 4. The system updates the location of Pool 3 and stores the updated location 970 in block 918 in Pool 4. The system updates the chain path 656 from one of the blocks, such as block 916, for the remainder of the pools in a similar manner up to Pool n. Note that pools need not be chained together in order. For example, step 2 chains Pool 2 to Pool 4 and Pool 4 to Pool 3. Further, the chain path can include the same pool multiple times. The chain path can also exclude one or more pools. These approaches can provide additional complexity to raise the difficulty and cost threshold of reverse engineering. Again, pointer ptr2 in pool n points to the desired data. Other desired data can be obtained from ptr1 in pool 1 or ptr3 in pool 4.

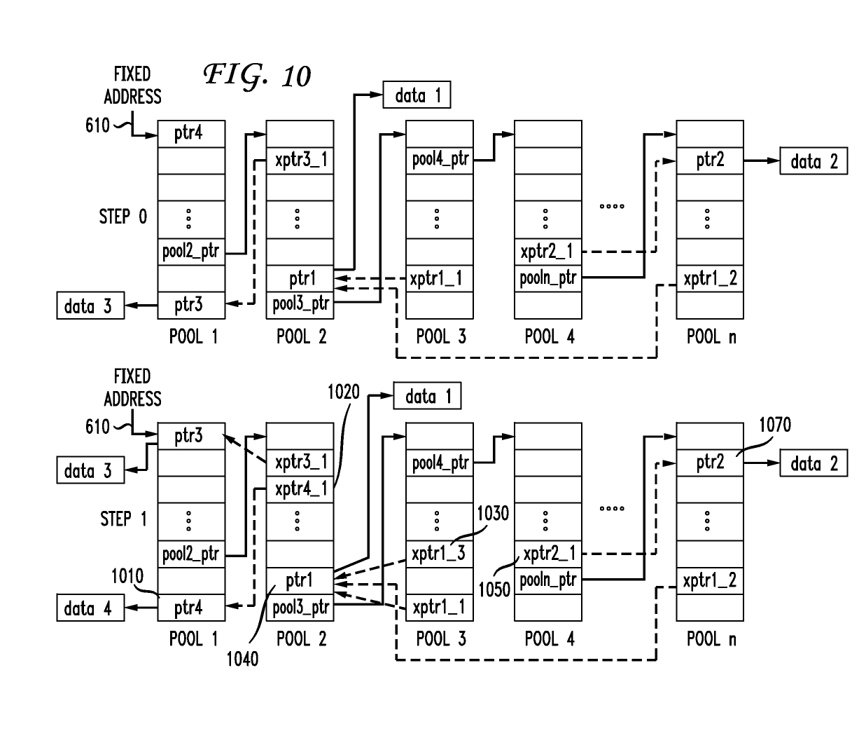

FIG. 10 illustrates two additional pointer shuffling operations, pool entry shuffling and cross-pointer shuffling. Pool entry shuffling and cross-pointer shuffling operate directly on the entries of the pools, not the chaining between them. Cross-pointer addition, removal and shuffling are the processes of adding, removing or shuffling a cross-pointer. In pool entry shuffling, the system 100 replicates, switches, or moves some of the pointers located in the pools. FIG. 10 illustrates cross-pointers as dotted arrows between the pools.

Step 0 in FIG. 10 illustrates the state of the pools before a pool entry shuffling or cross-pointer shuffling operation. The pointers ptr1, ptr2, ptr3 and ptr4 point to actual data in memory respectively data1, data2, data3, and data4. Cross-pointers xptr1_1, xptr1_2, xptr2_1, and xptr3_1 point to other pointers. The cross-pointers xptr1_1 and xptr1_2 point to ptr1. Pointer xptr2_1 points to ptr2 in the last block 1180 of Pool n. Pointer xptr3_1 points to ptr3. Pointer pool2_ptr points to Pool 2. Pool3_ptr points to Pool 3. Pool4_ptr points to Pool 4 1160. Pooln_ptr points to Pool n.

In step 0, a function can lead through a path of the pools to retrieve the data. For example, a function could traverse a path from pool 1, using pool2_ptr, to pool 2, and go to pool 3 via pool3_ptr. For pool 3, the function could use pool4_ptr to find pool 4 and then use xptr2_1 to locate ptr2 in pool n, which points directly to data2. Other pointer paths such as moving from pool n to pool 2 via ptr1_2 or from pool 3 to pool 2 via xptr1_1 could be used. The multiple pointers in the pools can further confuse a hacker trying to access the data.

Step 1 illustrates the state of the pools after the system performs pool entry shuffling and cross-pointer addition. The system 100 updates the location of ptr4 between Step 0 and Step 1 by performing a pool entry shuffle. After the shuffle, pointer ptr4 is stored in block 1010 in Pool 1. Before the shuffle, pointer ptr4 was located in the first block of Pool 1. In Step 1, the system demonstrates cross-pointer addition by adding cross-pointer xptr4_1 to Pool 2 as is shown in block 1020. Prior to this addition, no references to ptr4 existed. Again, the system demonstrates cross-pointer addition by adding cross-pointer xptr1_3 to Pool 3 in block 1030. In addition to pointers xptr1_1 and xptr1_2, xptr1_3 points to ptr1.

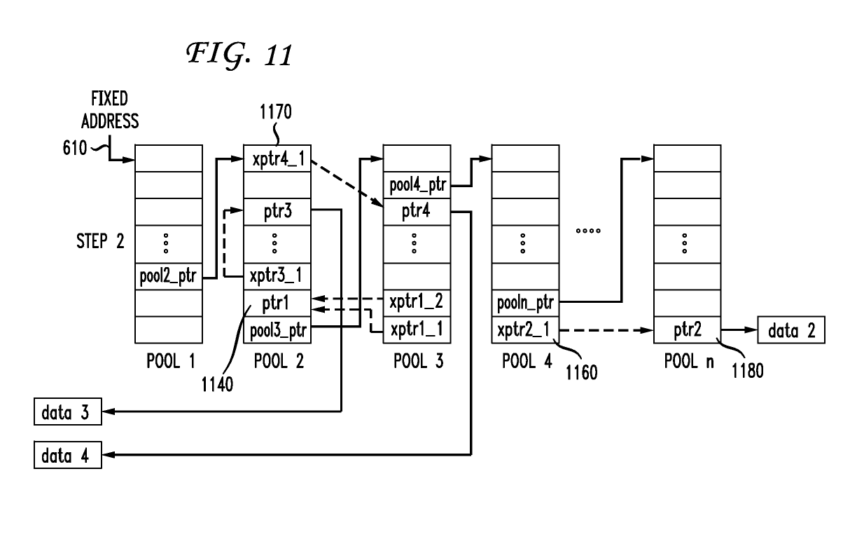

In FIG. 11, Step 2 illustrates cross-pointer shuffling and removal. The system 100 performs cross-pointer removal between Steps 1 and 2. In Step 1, ptr1 in block 1040 of pool 2 has three cross-pointers pointing to it, xptr1_1, xptr1_2 and xptr1_3. In Step 2, ptr1 in block 1140 of pool 2 has two cross-pointers pointing to it, xptr1_1 and xptr1_2. The third cross-pointer xptr1_3 was removed. Step 2 also illustrates cross-pointer shuffling. In Step 1, the system 100 stores xptr3_1 in the second block in Pool 2. In Step 2, the system stores xptr3_1 in a different block. Other changes in the pools are shown in Step 2. For example, ptr4 can be moved from pool 1, as shown in Step 0, to pool 3 (and still point to data 4), ptr3 can be moved from pool 1 to pool 2 (and still point to data 3), and xptr1_2 can be moved from pool n to pool 3 (and still point to ptr1 in pool 2). Still other changes include moving ptr2 to data 2 from one block to another block within pool n. In Step 2 it is stored in the last entry 1180 of Pool n. Cross-pointer removal or shuffling can remove or shuffle a cross-pointer within and among the pools of pointers. The removal and shuffling of pointers renders it more difficult to access the data.

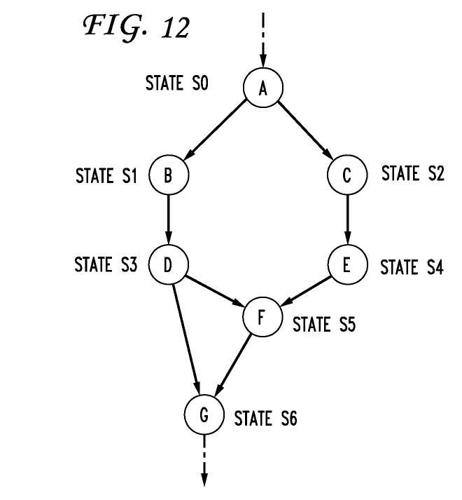

Using the technique of pointer obfuscation creates a dependency between different functions within source code since they are using shared data. FIG. 12 illustrates this dependency using an exemplary call graph. The system 100 creates a call graph that is used to track pointers at different points within a computer program execution. Each node in the graph (A, B, C, D, E, F, G) represents a function and each edge (F,G, for example) indicates that the function F calls function G. States S0, S1, S2, S3, S4, S5 and S6 describe the state of the pools of pointers when reaching these nodes. The dependency between functions increases the difficulty for an attacker to gain access to the data. It is more difficult for an attacker to lift part of code (copy part of the code in order to integrate it into another standalone program) or try to directly execute a portion of a program. Attackers are often interested in executing a specific portion of the targeted program without having to understand or reverse engineer it, as is the case with cryptographic routines. For instance, rebuilding structures of pointers for an attacker is not easy since memory must be allocated and the structures must be filled in properly in order to follow the right path through the pools to get the data.

When the system 100 reshuffles pools and utilizes shared data through multiple levels of indirection, the system 100 effectively creates a state machine representation. A state machine is a model of behavior composed of a finite number of states, transitions between those states, and actions. In FIG. 12, the path of nodes A, C, E, F leads to State S5. The path of nodes A, B, D, F also leads to State S5. The system 100 can reach State S6 through three different paths: A, B, D, G; A, B, D, F, G; and A, C, E, F, G. The state machine approach shows that multiple paths can produce the same state, as is the case with States S5 and S6. The state machine can track the states of the pool of pointers throughout program execution. However, other methods are also contemplated for tracking the states of pointers.

The obfuscation process discussed herein can add performance overhead, however it can be controlled by limiting the number of indirections to data and limiting the amount of data to which the solution applies. In terms of performance overhead, expensive memory access takes a greater amount of time to retrieve data from memory than an inexpensive memory access does. Access to the pointers located in the first pool does not lead to any performance overhead once they are set. The pools that are located the farthest away in memory are the most expensive to access in performance terms, but this is controlled by assigning the location of the most frequently used pointers to the closest pools. The expensive actions of this obfuscation process have been discussed above: pool entry shuffling, pool chaining shuffling and cross-pointer shuffling. On repetitive tasks requiring high performance, the number of calls to these three features can be lowered. A programmer can add flags explicitly designating portions of source code as higher performance or lower performance, or the system can automatically determine how to allocate expensive and inexpensive actions based on security, performance, memory constraints, and/or other considerations. Thus, one aspect of this disclosure relates to a variation of parameters which guide the system to implement an expensive, inexpensive, or hybrid obfuscation based on such factors as source code performance for particular portions of source code, desired level of protection for specific pieces of data (such as social security numbers and cryptographic keys), and so forth.

Embodiments within the scope of the present disclosure may also include tangible computer-readable storage media for carrying or having computer-executable instructions or data structures stored thereon. Tangible computer-readable storage media is non-transitory. Such computer-readable storage media can be any available media that can be accessed by a general purpose or special purpose computer, including the functional design of any special purpose processor as discussed above. By way of example, and not limitation, such computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method of data reference obfuscation, the method causing a computing device to perform steps comprising:
locating pointers to data within source code;
loading the pointers within the source code into an ordered set of pools;
shuffling the pointers in the ordered set of pools; and
adding a function within the source code that when executed uses the ordered set of pools to retrieve the data.

2. The method of claim 1, wherein the function to retrieve the data performs steps comprising:
(1) selecting a pointer in a first pool in the ordered set of pools;
(2) following the selected pointer or selected next pointer to identify a next pool in the ordered set of pools;
(3) defining the next pool as a current pool and iteratively selecting a next pointer in the current pool and returning to step (2) until a second function indicates that the selected next pointer in the current pool points to the data.

3. The method of claim 1, wherein the pointers are shuffled deterministically.

4. The method of claim 1, wherein the pointers are shuffled randomly.

5. The method of claim 1, wherein the pointer to data within source code is replaced with the function to retrieve the data.

6. The method of claim 1, wherein the ordered set of pools is generated by merging function input parameters together.

7. The method of claim 1, wherein a first pool in the ordered set of pools has a fixed address.

8. The method of claim 1, the method further causing the computing device to automatically select the ordered set of pools of pointers based on desired performance attributes.

9. A computing device having a processor and a memory, the memory storing a computer program having instructions for controlling the processor to perform certain steps, the instructions including obfuscated data references generated according to steps comprising:
locating pointers to data within the instructions;
loading the pointers within the instructions into an ordered set of pools;
shuffling the pointers in the ordered set of pools in the instructions; and
adding a function within the instructions that when executed uses the ordered set of pools to retrieve the data.

10. The computing device of claim 9, wherein shuffling pointers in the ordered set of pools of pointers to data further includes at least one of pool entry shuffling, pool chaining shuffling, and cross-pointer shuffling.

11. The computing device of claim 9, wherein the pointer to data within source code is replaced with the function to retrieve the data.

12. The computing device of claim 9, wherein the ordered set of pools is generated by merging function input parameters together.

13. The computing device of claim 10, wherein pool entry shuffling includes at least one of replicating, switching or moving pool entries within a pool.

14. The computing device of claim 10, wherein pool chaining shuffling further comprises:
identifying the first pool in the ordered set of pools with a fixed address; and
modifying the location of the next pool link within a pool.

15. The computing device of claim 10, wherein a cross-pointer is a data pointer to a data pointer.

16. The computing device of claim 10, wherein cross-pointer shuffling further includes at least one of addition of a cross-pointer, removal of a cross-pointer, replication of a cross-pointer, and switching or moving of a cross pointer.

17. The computing device of claim 9, further causing the computing device to create a state machine using the reshuffling pools and shared data through multiple levels of indirection.

18. A computer-readable storage medium storing a computer program having instructions which, when executed by a computing device, cause the computing device to retrieve obfuscated data, the instructions comprising:
(1) selecting a pointer in a first pool in the ordered set of pools;
(2) following the selected pointer or selected next pointer to identify a next pool in the ordered set of pools; and
(3) defining the next pool as a current pool and iteratively selecting a next pointer in the current pool and returning to step (2) until a second function indicates that the selected next pointer in the current pool points to the data.

19. The computer-readable storage medium of claim 18, the instructions further comprising automatically selecting the ordered set of pools of pointers based on desired performance attributes.

20. A system for obfuscating data references, the system comprising:
a processor;
a module that controls the processor to locate pointers to data within source code;
a module that controls the processor to load pointers within the source code into an ordered set of pools;
a module that controls the processor to shuffle the pointers in the ordered set of pools; and
a module that controls the processor to add a function within the source code that when executed uses the ordered set of pools to retrieve the data.

21. The system of claim 20, wherein the module that controls the processor to shuffle the pointers in the ordered set of pools further controls the processor to perform at least one of pool entry shuffling, pool chaining shuffling, and cross-pointer shuffling.

22. The system of claim 20, wherein pool entry shuffling includes at least one of replicating, and switching or moving pool entries within a pool.

23. The system of claim 20, wherein pool chaining shuffling further comprises:
identifying the first pool in the ordered set of pools with a fixed address; and
modifying the location of the next pool link within a pool.

24. The system of claim 20, wherein a cross-pointer is a data pointer to a data pointer.

25. The system of claim 20, wherein cross-pointer shuffling includes at least one of addition of a cross-pointer, removal of a cross-pointer, replication of a cross-pointer, and switching or moving of a cross pointer.

26. The system of claim 20, further comprising a module that controls the processor to create a state machine using the reshuffling pools and shared data through multiple levels of indirection.
